(19) United States
(12) Patent Application Publication
(10) Pub. No.: US 2026/0228545 A1
(43) Pub. Date: Aug. 6, 2026

(54) PRIVACY-PRESERVING TRAINING DATA TRANSFORMATION FOR MACHINE LEARNING

(71) Applicant: Theta Lake, Inc., Santa Barbara, CA (US)

(72) Inventors: Rohit Jain, Ventura, CA (US); Andrea Varga, Sheffield (GB); David Pfeiffer, Reno, NV (US); Guru Radhakrishnan, Norwich (GB)

(21) Appl. No.: 19/045,127

(22) Filed: Feb. 4, 2025

(51) Int. Cl. G06N 3/091

(52) U.S. Cl. CPC G06N 3/091

(57) ABSTRACT

Systems and methods leverage the capabilities of large language models (LLMs) to generate training data from sensitive data without exposing sensitive information in the sensitive data. In some embodiments, sensitive data is fed to the LLM in an automated manner along with a customized prompt asking the LLM to rephrase the text while mutating specific types of entities in specific ways to generalize the content to other entities that are similar. In some examples, in addition to paraphrasing the sensitive data, items in the data can be switched out (effectively anonymizing), for example, entity names, people's names, dates, times, numerical values, etc.

### TECHNICAL FIELD

This disclosure relates generally to the field of machine learning. More particularly, embodiments relate to generating privacy preserving training data for such models, using foundational models.

### BACKGROUND

For machine learning models to perform effectively, they must be trained using data that closely resembles data they will encounter in real-world applications. This alignment ensures the models can accurately interpret and respond to the input they receive. For instance, if a model is designed for use within a particular industry or specialized field, its training data should reflect the unique vocabulary, terminology, and industry-specific jargon that are prevalent in that domain. This specialized training ensures the model can understand and process the nuances of the language used in that specific context, thereby enhancing its accuracy and reliability in practical use cases. By meticulously matching the training data to the characteristics of the application data, the performance and relevance of the machine learning model are significantly improved.

Despite the importance of utilizing source data for training machine learning models, it is desirable to ensure that this training data remains confidential and private. The sensitive nature of the source data necessitates stringent measures to protect it during the training process. Consequently, it is desired to develop methods that allow for the effective use of this sensitive data in model training while simultaneously reducing security and privacy risks. Achieving this balance is essential to maintaining data privacy and ensuring the integrity of the models being trained. Therefore, finding innovative solutions to securely incorporate sensitive data into machine learning workflows is a priority.

Previous solutions for training models on data while preserving data privacy such as differential privacy, homomorphic encryption, federated learning, or multi-party computation require complex solutions. Each of these previous solutions has various drawbacks and disadvantages, as outlined below.

Differential privacy is a mathematical framework that ensures individual privacy within a dataset while allowing for useful data analysis. It achieves this by adding random noise to the data, making it difficult to identify any specific individual's information. However, adding noise to data to ensure privacy can reduce the accuracy of the results. In addition, implementing differential privacy algorithms can be complex and requires careful tuning.

Homomorphic encryption is a type of encryption that allows computations to be performed on encrypted data without decrypting it first. This means you can analyze and process the data while keeping it secure, and the results, when decrypted, are the same as if the operations had been performed on the unencrypted data. However, homomorphic encryption requires significant computational resources, leading to slower processing times compared to traditional methods. Due to its computational overhead, homomorphic encryption is less practical for real-world applications.

Federated learning is a machine learning approach where multiple devices collaboratively train a model without sharing their raw data. Each device processes its data locally and only shares the updates or gradients with a central server, preserving data privacy and security. However, data distributed across devices is often not independently and identically distributed, which can affect model performance. In addition, frequent communication between devices and the central server can consume considerable bandwidth and slow down the training process.

Multi-party computation is a cryptographic protocol that allows multiple parties to jointly compute a function over their inputs while keeping those inputs private. Each party only knows its own input and the final result, ensuring data privacy during the computation process. However, implementing multi-party computation protocols is complex and requires significant computational resources. In addition, multi-party computation protocols often require multiple rounds of communication between parties, which can be slow and resource intensive.

Other prior art methods of addressing these problems relate to augmenting data in certain ways using natural language processing (NLP) techniques or generating data in general using NLP techniques. For example, replacing entities in a chunk of text using NLP. However, these types of solutions are also fragile and limited. LLMs are better at this because of their longer context lengths, better understanding of that larger context, and the language substitutions being grounded in a better understanding of human languages. The large size of these models, in terms of learnable parameters and therefore learning capacity, combined with huge training datasets results in models that have a much more nuanced and deep understanding of human language patterns and consequentially they are more effective in anonymizing and augmenting data.

As outlined above, each one of these prior art techniques requires a compromise either on model accuracy, high computation cost, restricted data types, or limits the types of models and where they can run. The approach described herein circumvents all these weaknesses and is much easier to use.

### SUMMARY

Systems and methods for generating training data for large language models (LLMs) are described that, in some embodiments, include receiving sensitive input data; providing a prompt to a large language model (LLM) trained to generate output data, the prompt specifying that source text in the input data be rephrased and specifying that certain indicators in the source text be anonymized; and training another machine learning model using the data thus generated.

Embodiments of the present invention also include computer-readable storage media containing sets of instructions to cause one or more processors to perform the methods, variations of the methods, and other operations described herein.

In some embodiments of the present invention, methods include receiving a selection from a user of one or more data augmentation processes, and for each of the selected data augmentation processes, providing a prompt to the LLM to augment the new training data that is configured for the respective data augmentation process. Note that as discussed throughout this application, where references are made to submitting prompts and inputs to LLMs, the LLMs will not retain or train on any prompt or input data.

In some embodiments of the present invention, methods include providing a second prompt to the LLM to generate new LLM training data, the prompt configured to generate new training data that is different from, but semantically similar to the output data.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, or rearrangements may be made within the scope of the disclosure without departing from the spirit thereof, and the disclosure includes all such substitutions, modifications, additions, or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 is a diagram depicting an example of processes for using an LLM to generate training data.

FIGS. 2-3 are flow charts depicting exemplary processes for generating training data for large language models.

FIG. 4 is a diagrammatic representation of one embodiment of a network environment.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

Generally, the disclosed systems and methods leverage the capabilities of modern large language models (LLMs) to generate training data from sensitive data without the model developer directly accessing said data. Note that the LLMs are not trained or retrained using any of the sensitive data. In some embodiments, a corpus of actual sensitive data is fed to the LLM in an automated manner along with a customized prompt asking the LLM to rephrase the text while mutating specific types of entities in specific ways so as to generalize the content to other entities that are similar. In some examples, in addition to paraphrasing the sensitive data, items in the data can be switched out (effectively anonymizing), for example, indicators such as entity names, people's names, dates, times, numerical values, etc. This approach essentially creates new training data from sensitive data, without disclosing the initial sensitive data in any way. In some embodiments, off-the-shelf foundational LLMs can be used.

Other text augmentations can also be generated, such as temporal, grammatical, lexicographical variation, as well as translation into other languages. The disclosed novel data augmentation techniques for editing or creating training data for LLMs can focus on protecting sensitive data while maintaining semantic richness and utility. This approach systematically transforms training data by applying a variety of modifications, for example: changing tenses (e.g., from past to future), translating text between languages (e.g., English to Spanish), and altering numerical values such as prices or monetary amounts. Additionally, it replaces corporate and personal names with plausible alternatives, ensuring anonymity, and introduces or corrects misspellings to simulate real-world data variance. These augmentations may also include, but are not limited to replacing entities like names, places, companies, currencies, financial instruments, financial trades, addresses, personal identifiable information (PII) etc. Beyond augmenting existing datasets, this technique can also generate entirely new training data of the same type by synthesizing realistic and contextually coherent examples, further expanding the diversity and scope of training material. By diversifying and generating datasets through these methods, this approach minimizes the risk of sensitive information being reproduced while enhancing the model's ability to generalize across linguistic and contextual variations, making it a powerful tool for privacy-preserving LLM development.

This approach solves the problem of maintaining data confidentiality, while still allowing for the incorporation of language distribution from real world sensitive data into a training dataset. Additionally, by incorporating augmentations the disclosed approach makes the training data more diverse and the resulting classifiers more robust. These approaches can also extend support for non-English languages.

The disclosed solution is easier to understand, faster to implement and run, and enhances model performance rather than limiting model performance. Moreover, the disclosed solution can work on any kind of text data and can be extended to image, video, audio, and other types of data.

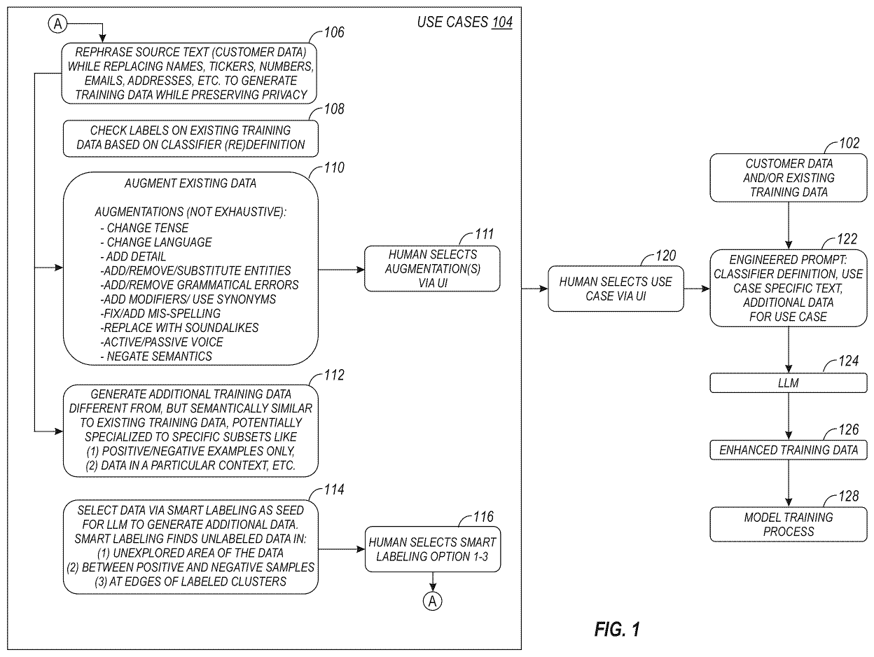

FIG. 1 is a diagram illustrating an example of processes for using an LLM to generate training

data from sensitive data in an automated fashion. The process starts with a source of data. As shown, sensitive data 102 and/or existing training data is provided. In some examples, the sensitive data 102 may include proprietary information, or information that otherwise may need to be kept confidential, when used as training data. FIG. 1 also shows a number of use cases 104, which may apply to a given process.

In a first use case 106, the LLM will be tasked with rephrasing the source text (e.g., sensitive data 102), while replacing names, tickers, numbers, emails, addresses etc. to generate training data, while at the same time, preserving privacy, as described above. Besides rephrasing the source text, other transformations can be performed on the language of the source text. Note that there can be overlap with the use case 106 and the use case 110 (described below).

In a second use case 110, the LLM will be tasked with augmenting existing data (e.g., sensitive data 102) in a number of ways, as chosen by a user. FIG. 1 provides various examples of ways to augment existing data, including, for example: changing the tense of words or phrases, changing language, adding detail to the data, adding/removing/substituting entities identified in the data (e.g., company names, persons, locations, etc.), adding/removing grammatical errors, adding modifiers or using synonyms, fixing and/or adding mis-spellings, replacing words with soundalikes, changing active or passive voice, negating semantics, etc. Numerous other augmentations are also possible, as one skilled in the art would understand. In some embodiments, at 111, a user will select, via a user interface (UI), one or more of the available augmentations to be applied by the LLM. In other embodiments, selections are made without a UI. Note that, in some embodiments, as shown by the arrow coming from use case 106, the data to be augmented has already been rephrased, as discussed above, with any sensitive information removed.

In a third use case 112, the LLM will be tasked with generating additional training data different from, but semantically similar to, existing training data (e.g., sensitive data 102), potentially specialized to specific subsets such as (1) positive/negative examples only, (2) data in a particular context, etc. Note that, in some embodiments, as shown by the arrow coming from use case 106, the input data has already been rephrased, as discussed above, with any sensitive information removed.

In a fourth use case 114, the LLM will be tasked with using the concept of smart labeling to select data as seed for the LLM to generate additional data. Generally, smart labeling finds unlabeled data in unexplored areas of the data, between positive and negative samples in the data, and at edges of labeled clusters. A detailed description of techniques for using smart labeling is found in commonly-owned U.S. Patent Application Publication US-2023-0267175-A1, entitled, “SYSTEMS AND METHODS FOR SAMPLE EFFICIENT TRAINING OF MACHINE LEARNING MODELS,” which is incorporated by reference herein, in its entirety. In some embodiments, at 116, a user will select, via a user interface (UI), among the smart labeling options (e.g., 3 options are shown in 114) to be applied by the LLM. Note that, the concept of using smart labeling can be used to intelligently select a subset of the available data. In some embodiments, smart labeling can be used to select sub-sets of data prior to the rephrasing use case (106), as shown by the arrow reference (A). The data selected via smart labeling can then be processed via the three use cases listed above.

In a fifth use case 118, the LLM will be tasked with checking labels on existing training data, based on classifier (re)definition (described in more detail below).

Referring back to the beginning of the process illustrated in FIG. 1, sensitive data 102 and/or existing training data is provided. At step 120, a user selects one or more of the use cases 104, via a user interface (UI) to be applied by the LLM. Next, at 122, depending on which use case(s) 104 was selected by the user, an engineered prompt is selected, and provided to the LLM 124. The prompt may specify items such as a classifier definition, use case specific text, additional data for the use case, etc. Detailed examples of prompts, including samples of input and output data are provided below. In response to a prompt, the LLM will generate the enhanced training data 126, which may then be used in model training processes. At step 130, the generated data is reviewed. Note that, in some embodiments, all generated data is reviewed by a human before adding it to the training dataset. Finally, at step 132, another model is trained using the enhanced training data.

Following are several detailed examples of prompts and sample (input and output) data that could be used at step 122 for use cases 106, 118, 110, and 112. As background information, as one skilled in the art would understand, in the context of LLMs, a prompt is the input text or sequence provided to the LLM to elicit a response or generate an output. A prompt serves as the starting point or instruction that guides the LLM's output. Prompts can range from simple questions or statements to detailed instructions, examples, or contextual setups.

A first example relates to use case 106, where the LLM is asked to rephrase source text, as described above. Following are the prompt (step 122), the input data (step 102), and the output data (step 126). For clarity, a small sample of input data is provided. Note that the input data in these examples relate to an example where LLMs are trained to identify items in conversational text. Other types of input data can also be used, as one skilled in the art would understand.
PROMPT:
Paraphrase the following text in multiple different ways using as few words from the original text as possible while maintaining semantic consistency with the source text.
Use the following step by step process:
1. Start by extracting key points from the source text and then generate a different text version from those key points.
2. Replace entities such as company names, stock tickers, personal names, credit card numbers, emails, phones, addresses, places, dates, amounts, or any personal information like account numbers or identity related data.
For example, replace “John” with “Dave”, “Verizon” with “Microsoft”, “(805)555-6600” with “(216)555-9811”.
3. Try paraphrasing each sentence one by one. Keep the style, tone, and any jargon consistent with the source text.
4. Check that the paraphrased sentence is different from the original sentence but is semantically consistent. Check that entities are replaced.
Here is the original text:
INPUT:
Hey, listen, we need to get Tesla up before the earnings call. How about we all buy in tomorrow morning and drive it up a bit? We can dump it after the call if it goes well.
I'm going to release a fake news article about a major breakthrough at Palantir, hoping it will send their stock soaring. Then I'll sell my shares for a profit.
Let's coordinate our trades. We'll buy 10,000 shares at the same time to spike it. Then we'll sell for a quick profit.
I know someone with insider information about Oracle. They're about to release a new product. I'm going to buy a bunch of shares before the news breaks and make a killing.
OUTPUT:
Listen, we should uplift Apple prior to the product launch. How about jointly investing tomorrow morning to boost its value? If it goes well, we can sell off afterward. I'm planning to spread fake news about an impressive breakthrough at Google, aiming to raise their share price. Then I'll cash out for a gain. Let's align our investments. We'll acquire a large number of stocks simultaneously to drive up its value. Then, we can liquidate for immediate gains. I know someone with privileged insights about Amazon. They're about to unveil a cutting-edge innovation. I'll invest heavily before it's publicized and gain substantial profits.

As specified in the prompt, the LLM has generated output data that is a rephrased version of the input data. In addition, entities in the input data have been changed in the output data (e.g., “Tesla” to “Apple,” “Oracle” to “Amazon,” etc. As discussed above, one advantage of this is to enable the use of sensitive data as training data, without the risk of disclosing unwanted information.

A second example relates to use case 118, where the LLM is asked to check labels on existing training data based on classifier (re)definition. Following are the prompt (step 122), the input data (step 102), and the output data (step 126). In this example, the prompt includes information to direct the LLM to review example sentences that should (or not) be detected by a specific classifier. In this example, the input includes a classifier definition, and in actual use, would include lists of positively and negatively labeled training data.
PROMPT:
You are tasked with examining training data for a robust machine learning classifier which detects {definition}.
Here are some example sentences that are (not) detected by this classifier:
{examples}
Review the examples provided and list those that should (not) be detected by this classifier.
INPUT:
definition=‘complaints about alleged financial misconduct or incompetence’ Examples=positively labeled training data, then negatively labeled training data
OUTPUT:
Potentially incorrect positives (28 out of ~5000)
“not a great user experience for the prototypes for T&L”, “definitely not a great user experience”,
“good financial planner”,
“if you were managing my account, you would have moved me into something else”, “the complaints team already knows about this issue”,
“they were not even close to what their needs were”, “this company is unbelievable”,
“this company is licensed to handle anyone's money”, “this place is not worth it”,
“vegas has better odds for making money”
Potentially incorrect negatives (232 out of ~4000)
“Communication was astoundingly terrible; it took months for me to resolve the issue (which was clearly not my fault as I had a letter from my bank which provided proof of when the payment was sent).”,

A third example relates to use case 110, where the LLM is asked to apply selected augmentations to input data. Following are the prompt (step 122), the input data (step 102), and the output data (step 126). In this example, the prompt identifies augmentations (e.g., “adding more detail to make the example clearer or more specific” and “extending the example by adding additional entities such as persons, names, locations, organizations, temporal information, amount, currency or personally identifiable information,” and various other, as shown. As with a previous example a classifier definition is included, to indicate to the LLM the purpose of the classifier to be trained. In this example, the input would include a subset of training data (e.g., examples).
PROMPT:
You are tasked with generating new training data for a robust machine learning classifier which detects {definition}.
Here are some example sentences that should be detected by this classifier:
{examples}
Generate additional sentences based on the examples provided above by {augmentation}.
INPUT:
augmentations=[‘adding more detail to make the example clearer or more specific’, ‘extending the example by adding additional entities such as persons, names,
locations, organizations, temporal information, amount, currency or personally identifiable information’,
‘fixing any existing grammatical error or adding common grammatical errors’, ‘paraphrasing by adding noun modifiers or synonyms or in any other way’, ‘fixing any misspelling or replacing correct words with common misspellings’, ‘replacing existing entities with other entities that are similar’,
‘replacing words with other words that sound alike’, ‘changing active to passive voice or vice-versa’,
‘changing tense from present to future or past or vice-versa’,
‘translating to Italian, German, Spanish, French, Dutch, Portugese, Chinese, and Japanese.’,
‘negating the semantic sense of the sentence’]
definition=‘complaints about alleged financial misconduct or incompetence’ Examples=subset of training data
OUTPUT:
“Wall Street up, portfolio down. You figure? Not worth the 1% advisor's fiz.”,
“We came here to simplify our finances, which you did by losing us money on nearly every single investment you made for us during the historic bull markets of 2016-2019 . . . no money, no problems, right?”,
“We ended up paying you quite a lot of money and getting what we felt was as good as nothing in return.”,
“We had several hundred thousand collars of other investment money that you put into some poorly performing and unusually expensive (SEI) funds.”,
“We were charged $280.00 to complete our taxes and not only did you make several mistakes along the way, I finally had to go somewhere else to get the proper information to make sure we filed correctly and completely.”,
“What a scamper!!”,
“What their product is which one like the theft to me 100 and the other one to fund each of them doesn't have a high management frost because they're not actively sign respects better than come back.”,
“What was provided was a confusing amalgam of incomplete and/or incorrect information”,
“What you are doing doesn't make any cents.”,
“What you promised me and what I expected you to deliver did not happen”,
“What's going on? DCM (US): Look, your rates are steep and we have been getting some good service from some other brokers.”,

A fourth example relates to use case 112, where the LLM is asked to generate additional training data that is different from, but semantically similar to, existing training data. Following are the prompt (step 122), the input data (step 102), and the output data (step 126). In this example, the prompt specifies that the LLM is tasked with generating training data a robust machine learning classifier, and what the classifier is being trained to detect. The prompt also includes example sentences that are detected by this classifier. The prompt also asks the LLM to generate 100 diverse, new, and different sentences relevant to the definition of this classifier. The input data for this prompt would include examples of positives in the existing training data.
PROMPT:
You are tasked with generating training data for a robust machine learning classifier which detects {definition}.
Here are some example sentences that are detected by this classifier:
{examples}
Review the examples provided above to come up with at least 100 diverse, new, and different sentences relevant to the definition of this classifier.
INPUT:
definition=‘complaints about alleged financial misconduct or incompetence’ Examples=all positives in training data
OUTPUT:
“I will report your fraudulent practices to the regulatory authorities.”, “Your unethical behavior has caused me significant financial loss.”,
“I am considering legal action against your company for financial misconduct.”, “Your incompetence and negligence have cost me a substantial amount of money.”,
“I have filed a complaint with the Financial Ombudsman Service due to your dishonest business practices.”,
“Your misleading advice led to significant losses in the stock market.”,
“Your unauthorized handling of my money is a breach of trust and potentially illegal.”,
“I demand a refund for the fees I paid for your worthless financial advice.”,
“Your deceptive sales tactics and subpar investments resulted in poor returns for my portfolio.”,
“It is clear that your company prioritizes its own profits over the financial well-being of its clients.”,
“Your lack of transparency and dubious investment choices have left me with substantial financial losses.”,
“I am deeply dissatisfied with your financial management and will be transferring my assets elsewhere.”,

A fifth example also relates to use case 112, where the LLM is asked to generate additional training data which detects potentially risky sentences in communications data. This prompt defines the task of the LLM, and includes as input examples of statements that are considered true positive hits for this specific classifier. For brevity, sample output data is not provided here, but, as before, would include a list of 100 short sentences considered to be true positives for this classifier.
PROMPT:
You are tasked with generating training data for a robust machine learning classifier which detects potentially-risky sentences in communications data. Specifically, you are tasked with generating a list of short sentences that are considered true positive hits for the Change of Venue Classifier.
The Change of Venue Classifier attempts to detect statements suggesting that a conversation should be moved to an unmonitored communications platform and statements suggesting that something should not be said or discussed because the current communication platform which the participants are using to communicate is recorded or monitored. Such detections are considered true positive hits for the Change of Venue Classifier.
These are all the communication platforms that are considered monitored:
   Zoom, Ring Central, Cisco Webex, Microsoft Teams, Slack
   Fuze, Dialpad, Bluejeans, GoToMeeting, Sharepoint, Movius, Mural, Slido, Symphony
   Business email, business phone, work email, work phone
These are some of the communication platforms that are considered unmonitored:
   Talking in person, especially outside of the office
   Google Hangouts, Facetime, Skype
   LinkedIn, Facebook, Instagram, Twitter, Snapchat, TikTok, Clubhouse
   SMS, iMessage, Messenger, WhatsApp, Telegram, Signal, Discord, WeChat
   Matter Most, Kakaotalk, Threema, Voxer, Jabber, Chatter, Silence, Kik, Line, Wire, Flock
   Personal email, personal phone, private email, private phone, home phone, efax
For example, all of the following statements are considered true positive hits for the Change of Venue Classifier:
   We should move this conversation somewhere else.
   We shouldn't talk about that here.
   We should talk about this in person.
   We should move this conversation to Google Hangouts
   Let's connect on Facebook so we can discuss further
   Can you call my personal phone number?
   Text me on my personal number.
   Make sure to send that to my personal email address.
   Just so you know, this chat is being monitored.
   Careful, this call is being recorded.
   Let's continue this conversation in person.
   Let's continue this conversation on WeChat.
   Let's talk about that at the party later.
   Let's talk about that offline.
   Let's talk about that privately.
   Call my personal cell phone 209-480-2391
   Send that to my personal email: david@yahoo.com
   Let's talk about that outside of work
   Slack is monitored, let's discuss this on WhatsApp instead.
   Let's continue this discussion later tonight at the bar
   This is something we should talk about on WeChat
   I think the best place to have this discussion is Telegram
   What is your username on Facebook?
   Hit me up on iMessage or FB Messenger
   Send that to me on Signal
Generate a list of 100 short sentences that are considered true positive hits for the Change of Venue Classifier. The sentences should use different linguistic patterns from the example sentences above and should be clear and unambiguous.

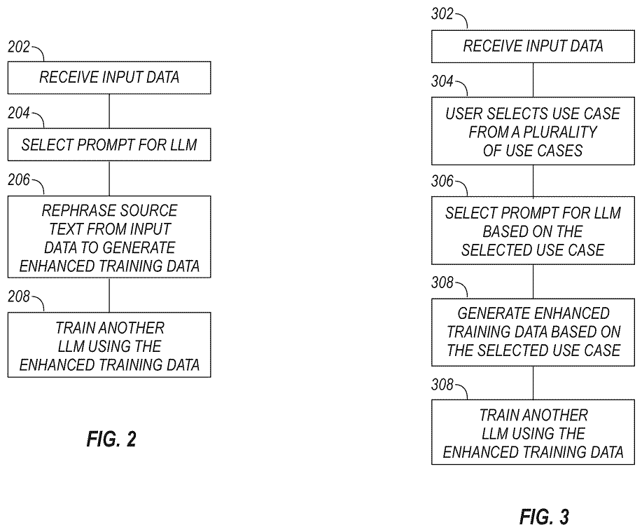

FIGS. 2-3 are flow charts depicting exemplary processes for generating enhanced training data for LLMs. As is evident from FIG. 1, numerous other examples are also possible. In the example shown in FIG. 2, input data is received (step 202). At step 204, an engineered prompt is selected for use by an LLM. As described in detail above, the prompt is configured as desired, for example for rephrasing source text and specifying that certain indicators in the source text be anonymized. In response, at step 206, the LLM generates enhanced training data from the input data, based on the applied prompt. At step 208, the generated data is reviewed. In some embodiments, the data is reviewed by a human. At step 210, another model is trained, using the enhanced training data.

FIG. 3 is a flow chart similar to the flow chart in FIG. 2, illustrating the use of a plurality of use cases. In the example shown in FIG. 3, input data is received (step 302). At step 304, a user selects a user case from the plurality of use cases. Several examples of use cases are described above with respect to FIG. 1. At step 306, an engineered prompt is selected for use by an LLM, based on the selected use case. In response, at step 308, the LLM generates enhanced training data from the input data, based on the prompt associated with the selected use case. At step 310, the generated data is reviewed. In some embodiments, the data is reviewed by a human. At step 312, another model is trained, using the enhanced training data.

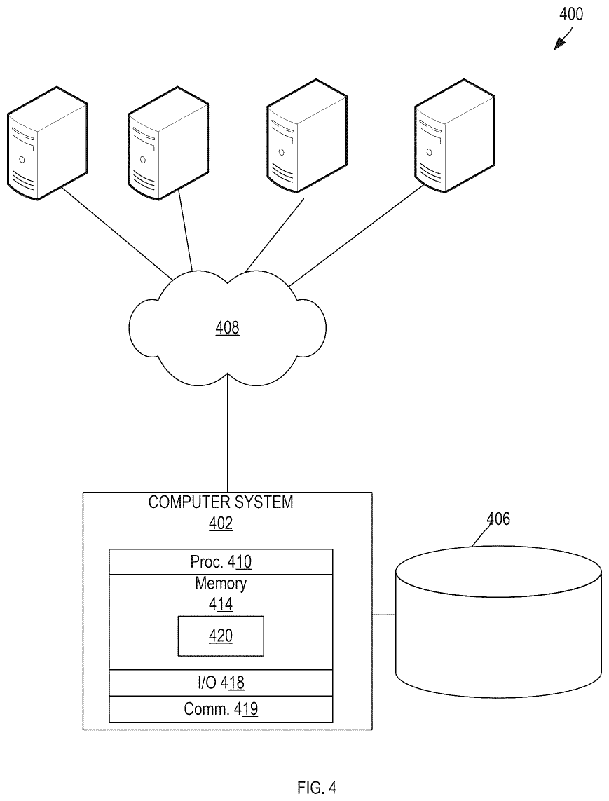

FIG. 4 is a diagrammatic representation of one embodiment of an architecture for a system for generating training data for large language models. The system may comprise one or more computer systems with central processing units executing instructions embodied on one or more computer-readable media where the instructions are configured to perform at least some of the functionality associated with embodiments of the present invention. In the illustrated embodiment, system 400 includes a computer system 402 having a computer processor 410 and associated memory 414. Computer processor 410 may be an integrated circuit for processing instructions. For example, computer processor 410 may comprise one or more cores or micro-cores of a processor. Memory 414 may include volatile memory, non-volatile memory, semi-volatile memory or a combination thereof. Memory 414, for example, may include RAM, ROM, flash memory, a hard disk drive, a solid-state drive, an optical storage medium (e.g., CD-ROM), or other computer-readable memory or combination thereof. Memory 414 may implement a storage hierarchy that includes cache memory, primary memory or secondary memory. In some embodiments, memory 414 may include storage space on a data storage array. Computer system 402 may also include input/output (“I/O”) devices 418, such as a keyboard, monitor, printer, electronic pointing device (e.g., mouse, trackball, stylus, etc.), or the like. Computer system 402 may also include a communication interface 419, such as a network interface card, to interface with network 408, which may be a local LAN, a WAN such as the Internet, mobile network, or other type of network or combination thereof. Network 408 may represent a combination of wired and wireless networks that may be utilized for various types of network communications.

Memory 414 may store instructions executable by computer processor 410. For example, memory 414 may include code executable to provide an interface. According to one embodiment, memory 414 may include code 420 executable to provide a data security platform, such as data security platform 402. Data store 406, which may be part of or separate from memory 414, may comprise one or more database systems, file store systems, or other systems to store various data used by computer system 402.

Each of the computers in FIG. 4 may have more than one CPU, ROM, RAM, HD, I/O, or other hardware components. Portions of the methods described herein may be implemented in suitable software code that may reside within memory 414 or other computer-readable memory.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylus, touch pad, etc.), or the like.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used to implement the routines, methods, or programs of embodiments of the invention described herein, including C, C++, Java, JavaScript, HTML, or any other programming or scripting code, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways to implement the invention.

It is also within the spirit and scope of the invention to implement in software programming or code the steps, operations, methods, routines, or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more general purpose digital computers, by using application specific integrated circuits, programmable logic devices, field programmable gate arrays, optical, chemical, biological, quantum or nanoengineered systems, components and mechanisms may be used. In general, the functions of the invention can be achieved by any means as is known in the art. For example, distributed, or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system, or device. The computer readable medium can be, by way of example only, but not by limitation, an electronic, magnetic, optical, electromagnetic, infrared, or semiconductor system, apparatus, system, device, propagation medium, or computer memory. Such a computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any hardware system, mechanism or component that processes data, signals or other information. A processor can include a system with a general-purpose central processing unit, multiple processing units, dedicated circuitry for achieving functionality, or other systems. Processing need not be limited to a geographic location or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term (i.e., that the reference “a” or “an” clearly indicates only the singular or only the plural). Also, as used in the description herein, the meaning of “in” includes “in” and “on” unless the context clearly dictates otherwise.

What is claimed is:

1. A system for generating training data for large language models (LLMs) comprising:
a memory;
a processor; and
a non-transitory, computer-readable storage medium storing a set of instructions executable by the processor, the set of instructions comprising instructions for:
receiving input data;
providing a prompt to a large language model (LLM) trained to generate output data, the prompt specifying that source text in the input data be rephrased and specifying that certain indicators in the source text be anonymized;
reviewing, by a human, the generated output data; and
training another machine learning model using the data thus generated.

2. The system of claim 1, wherein the one or more indicators includes one or more of:
names, places, companies, currencies, financial instruments, financial trades, addresses, and personal identifiable information (PII).

3. The system of claim 1, the set of instructions further comprising instructions for
receiving a selection from a user of one or more data augmentation processes; and
for each of the one or more data augmentation processes, providing a prompt to the LLM to augment the output data, each prompt configured for the respective data augmentation process.

4. The system of claim 1, the set of instructions further comprising instructions for:
providing a second prompt to the LLM, the second prompt configured to generate new training data that is different from, but semantically similar to the output data.

5. The system of claim 1, wherein the input data includes an initial set of labeled examples and a set of unlabeled examples to be labeled, the set of instructions further comprising instructions for assigning training labels to the unlabeled examples.

6. A method for generating training data for large language models (LLMs) comprising:
receiving input data;
providing a prompt to a large language model (LLM) trained to generate output data, the prompt specifying that source text in the input data be rephrased and specifying that certain indicators in the source text be anonymized; and
training another machine learning model using the data thus generated.

7. The method of claim 6, wherein the one or more indicators includes one or more of:
names, places, companies, currencies, financial instruments, financial trades, addresses, and personal identifiable information (PII).

8. The method of claim 6, the set of instructions further comprising instructions for
receiving a selection from a user of one or more data augmentation processes; and
for each of the one or more data augmentation processes, providing a prompt to the LLM to augment the output data, each prompt configured for the respective data augmentation process.

9. The method of claim 6, the set of instructions further comprising instructions for:
providing a second prompt to the LLM, the second prompt configured to generate new training data that is different from, but semantically similar to the output data.

10. The method of claim 6, wherein the input data includes an initial set of labeled examples and a set of unlabeled examples to be labeled, the set of instructions further comprising instructions for assigning training labels to the unlabeled examples.

11. A computer program product comprising a non-transitory computer-readable medium storing instructions translatable by a processor for:
receiving input data;
providing a prompt to a large language model (LLM) trained to generate output data, the prompt specifying that source text in the input data be rephrased and specifying that certain indicators in the source text be anonymized; and
training another machine learning model using the data thus generated.

12. The method of claim 11, wherein the one or more indicators includes one or more of:
names, places, companies, currencies, financial instruments, financial trades, addresses, and personal identifiable information (PII).

13. The method of claim 11, the set of instructions further comprising instructions for
receiving a selection from a user of one or more data augmentation processes; and
for each of the one or more data augmentation processes, providing a prompt to the LLM to augment the output data, each prompt configured for the respective data augmentation process.

14. The method of claim 11, the set of instructions further comprising instructions for:
providing a second prompt to the LLM, the second prompt configured to generate new training data that is different from, but semantically similar to the output data.

15. The method of claim 11, wherein the input data includes an initial set of labeled examples and a set of unlabeled examples to be labeled, the set of instructions further comprising instructions for assigning training labels to the unlabeled examples.
